(19) United States
(12) Patent Application Publication
(10) Pub. No.: US 2024/0270327 A1
(43) Pub. Date: Aug. 15, 2024

(54) CARGO BED FOR AN AUTOMOBILE

(71) Applicant: Brian Park, San Marino, CA (US)

(72) Inventor: Brian Park, San Marino, CA (US)

(21) Appl. No.: 18/443,254

(22) Filed: Feb. 15, 2024

Related U.S. Application Data
(60) Provisional application No. 63/445,842, filed on Feb. 15, 2023.

(51) Int. Cl. B62D 33/02; B60P 1/64

(52) U.S. Cl. CPC B62D 33/0207; B60P 1/6427

(57) ABSTRACT

A cargo bed for an automobile is disclosed. The cargo bed has a frame having a first side, a second side, a front side and a back side, a top face supported by the frame, wherein the top face is configured to support cargo, a plurality of vertical rails positioned in parallel with the first side and the second side and under the top face. The vertical rails have a vertical channel disposed therein a wheel assembly positioned in the vertical channel and a plurality of rail mating connectors positioned at each end of the vertical rails, wherein the rail mating connector is configured to mate with the front side and the back side of the frame at predetermined positions so that the vertical rails are adjustable horizontally along the front side and the back side.

### REFERENCE TO RELATED APPLICATION

This application claims the benefit of U.S. Provisional Application No. 63/445,842 filed on Feb. 15, 2023 entitled Cargo Bed and Table Assembly for an Automobile, the entire contents of which are incorporated by reference here for all purposes.

### TECHNICAL FIELD

The present disclosure generally relates to a cargo bed assembly for an automobile, namely, pick-up trucks, box trucks, vans, trailers, or any assembly with a cargo bed. More specifically, the present disclosure relates to a multi-functional cargo bed and table assembly for a pick-up truck.

### BACKGROUND

Automobiles of different sizes are used to transport goods and merchandise from one place to another. Trucks, cargo vans and flatbeds, for example, have beds that vary in size depending upon the user's needs. Box trucks also utilize similar types of beds but have covered beds rather than open beds.

Generally, users must physically get into the bed to retrieve items that are located closest to the cab because they cannot reach into the middle or back of the bed from the side. Furthermore, beds have a limited amount of space, and because many trucks are used for commercial work, space must be maximized. Lastly, in modern truck designs, truck beds have become inaccessible from the side of the bed because truck bed designs are too high.

Several approaches have been previously suggested to assist users to reach items in the back of the truck and make loading and unloading easier. Many of these solutions utilize rail systems that require modification of the truck, namely by drilling a rail system in the truck bed, which is expensive and leaves the cargo area permanently modified. Further, these designs are extensive and add a lot of additional weight.

However, these past designs are difficult to install and usually installed by professional at added cost, are not low-profile, nor do they have all of the desired functionality that some users may require. Furthermore, they are heavy and do not properly fit into all types of truck beds due to different widths and sizes of truck bed channels.

Therefore, there is a need for a multi-functional cargo bed assembly for automobiles, namely, pick-up trucks, vans, box trucks, trailers, or any assembly with a cargo bed.

### SUMMARY

The present disclosure describes a cargo bed assembly for an automobile or any motive assembly that has a flat bed, namely, pick-up trucks, box trucks, trailer, or any vehicle or motive assembly with a cargo bed. Also, the present disclosure discloses a multi-functional cargo bed table assembly or platform assembly for pick-up trucks, which extends by rolling out at any given distance to reach materials in the truck bed without stepping into the truck bed. Further, the present disclosure discloses a multi-functional platform assembly that uses one or more table legs to use the truck bed as an extending table or stand-alone separate table.

According to the present disclosure, the platform assembly provides a multi-functional rolling or sliding table that is positioned in a truck bed and locked. In one embodiment, the platform assembly is a convertible bed slide that lays flat on a compact, mid-size, or full-size pick-up truck or any automobile motive assembly with a bed. When the truck lift-gate is down, the platform assembly can be rolled or slid out at any given distance so that a user can reach materials in a truck bed without stepping into the truck bed. In one embodiment, a portion of the platform assembly may be pulled out, and one side of the platform assembly, via folding legs, may be propped up and used as a table. In another embodiment, the entire platform assembly may be pulled out to be used as a separate table.

A cargo bed for an automobile is disclosed. The cargo bed comprises a frame having a first side, a second side, a front side and a back side; a top face supported by the frame, wherein the top face is configured to support cargo; a plurality of vertical rails positioned in parallel with the first side and the second side and under the top face, wherein each of the plurality of the vertical rails comprises a vertical channel disposed therein; a wheel assembly positioned in the vertical channel; a plurality of rail mating connectors positioned at each end of the vertical rails, wherein the rail mating connector is configured to mate with the front side and the back side of the frame at predetermined positions so that the vertical rails are adjustable horizontally along the front side and the back side.

A method for removing a cargo bed from a cargo area to load and unload cargo is provided. The method comprising providing a frame having a first side, a second side, a front side and a back side; supporting cargo using a top face supported by the frame; adjusting a width of a plurality of vertical rails positioned in parallel with the first side and the second side and under the top face, wherein each of the plurality of the vertical rails comprises a vertical channel disposed therein; a wheel assembly positioned in the vertical channel; a plurality of rail mating connectors positioned at each end of the vertical rails, wherein the rail mating connector is configured to mate with the front side and the back side of the frame at predetermined positions so that the vertical rails are adjustable horizontally along the front side and the back side; pulling, pushing, or both, the cargo bed into and out of an automobile.

The wheel assemblies are configured to support the sliding movement of the platform assembly. In one embodiment, the wheel assemblies include a bow wheel assembly and a stern wheel assembly, which in some embodiments may be used as dolly wheels such that the table may also be used as a dolly once disconnected from the bed (we could have an embodiments with a set of wheels on the back side portion). A plurality of wheels run vertically in columns from bow to stern and may be arranged in rows, or in other embodiments, may be off-set relative to the wheel in the other row.

In one embodiment, the assembly may comprise handles (or hand-holds) on one end such that the assembly may be easily pulled out and in on the bed by the user, or in other embodiments, function as a dolly. The handles may extend from the back rail, and the wheels on the front rail may function as dolly rolling wheels.

In one embodiment, the platform assembly further comprises one or more leg assemblies. In one embodiment, the platform assembly comprises at least two sets of leg assemblies. The leg assemblies include a bow leg assembly and a stern leg assembly. In one embodiment, the leg assemblies are height adjustable for uneven surfaces. In one embodiment, each leg of the leg assemblies is height adjustable configured to use the table on any uneven surfaces.

In one embodiment, the bow leg assembly comprises a pair of bow legs including a right bow leg and a left bow leg, in addition to a bow bracket. The bow bracket is attached to a lower end (or non-adjustable portion) of each bow leg and comprises one or more cuffs including a right bow cuff and a left bow cuff. The bow leg assembly further comprises a middle bow brace, which is attached to the base of the platform assembly.

In one embodiment, the stern leg assembly comprises a pair of stern legs including a right stern leg and a left stern leg. In one embodiment, the stern leg assembly further comprises a stern bracket. The stern bracket is attached to a lower end (or non-adjustable portion) of each stern leg. In one embodiment, the stern bracket comprises one or more cuffs including a right stern cuff and a left stern cuff. In one embodiment, the stern bracket is attached to the lower end of the stern legs using the stern cuffs. In one embodiment, the stern leg assembly further comprises a middle stern brace. The middle stern brace comprises a first end and a second end. The first end of the middle stern brace is attached to the base of the platform assembly, whereas the second end is attached to the stern bracket.

In one embodiment, each middle brace comprises an interior bore for receiving the brackets and a lever configured to provide a quick-lock mechanism for easily folding and unfolding the leg assemblies. Each leg of the leg assemblies comprises a pivot joint configured to allow folding and unfolding of the leg assemblies. In one embodiment, the pivot joint comprises a pivot bolt or pivot rod for connecting the legs to the stern bracket, thereby providing pivotable movement of the legs for uneven surfaces, but other types of picot mechanisms may be used.

In one embodiment, the platform assembly further comprises one or more handles on the back rail. In one embodiment, one or more handles include a right stern handle and a left stern handle.

Other features and advantages of the present disclosure will become apparent from the following detailed description. It should be understood, however, that the detailed description and the specific examples, while indicate specific embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

Aspects of the present disclosure are illustrated by way of example and are not limited by the accompanying figures for which like references indicate like elements.

FIG. 1 shows a top perspective view of a table or bed slide tray or platform assembly for a truck bed of a pick-up truck in an embodiment of the present disclosure.

FIG. 2 shows a perspective view of the platform assembly in one embodiment of the present disclosure.

FIG. 3 show a side view of the platform assembly in one embodiment of the present disclosure.

FIG. 4a shows a perspective view of a rail of the platform assembly in one embodiment of the present disclosure.

FIG. 4b shows a front view of a channel of the rail of the platform assembly in one embodiment of the present disclosure.

FIG. 5a shows a perspective view of a truck bed channel for which the assembly adjusts to in an embodiment of the present disclosure.

FIG. 5b shows a top perspective view of the assembly for a truck bed showing adjustability mechanisms in an embodiment of the present disclosure.

FIG. 6 shows a perspective view of a wheel assembly of the platform assembly in one embodiment of the present disclosure.

FIG. 7 shows a top perspective view of the base of the platform assembly with adjustment channels in one embodiment of the present disclosure.

FIG. 8 shows a bottom perspective view of the base of the platform assembly with legs in an open position in one embodiment of the present disclosure.

FIG. 9 shows a top perspective view of the base of the platform assembly with legs in the extended position in one embodiment of the present disclosure.

FIG. 10 shows a bottom perspective of the base of the platform assembly with legs in a stowed position in one embodiment of the present disclosure.

FIG. 11 shows a single leg of any leg assemblies in one embodiment of the present disclosure.

FIG. 12a shows a perspective view of a locking bracket in one embodiment of the present disclosure.

FIG. 12b shows another perspective view of a locking bracket in one embodiment of the present disclosure.

FIG. 13 shows a brace assembly in one embodiment of the present disclosure.

FIG. 14 shows a bottom perspective of the base of the platform assembly with leg assemblies that close inwardly parallel in an open position and stowed position in one embodiment of the present disclosure.

### DETAILED DESCRIPTION

Exemplary embodiments are discussed below with reference to the Figures.

In the descriptions above and in the claims, phrases such as “at least one of’ or “one or more of’ may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub combinations of the disclosed features and/or combinations and sub combinations of several further features disclosed above. In addition, the logic flows depicted in the accompanying figures and/or described herein do not necessarily require the particular order shown, or sequential order, to achieve desirable results. Other implementations may be within the scope of the following claims.

The described embodiments are to be considered in all respects only as illustrative and not restrictive. The scope is, therefore, indicated by the appended claims rather than by the foregoing description. All changes that come within the meaning and range of equivalency of the claims are to be embraced within their scope.

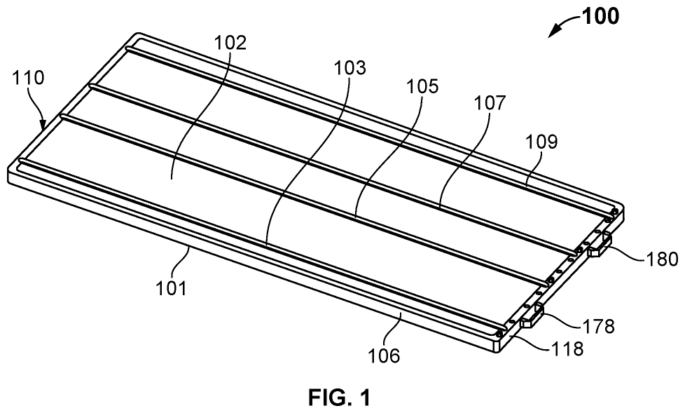

Referring to FIG. 1, a top perspective view of a combination table and bed slide tray or a slidable platform assembly (hereinafter referred as platform assembly) 100 for a pick-up truck or other type of motive transport, that also converts into a stand-alone table, or in embodiments, a table that is partially disposed in the truck bed and partially located outside of the truck bed. In this way, the platform assembly 100 provides a multi-functional rolling or sliding bed and a table to use apart from the truck bed. In one embodiment, the platform assembly 100 is a convertible bed slide that lays flat on a compact, mid-size, or full-size pick-up truck. When the truck lift-gate is down, the platform assembly 100 can be rolled out at any given distance in which a user can easily reach materials on the truck bed without stepping into the truck bed. In one embodiment, a portion of the platform assembly 100 may be pulled out and propped up using foldable, adjustable, and lockable legs. In one embodiment, the entire platform assembly 100 may be pulled out to use as a separate table meaning there may be two pairs of legs.

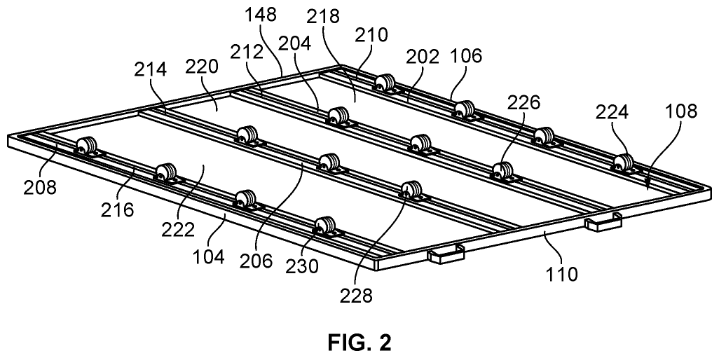

With reference still to FIG. 1, the platform assembly 100 comprises a frame 101 having four interconnected sides configured to support a face 102. The frame 101 has a right side 104, a left side 106, a front side 110, a back side 118, and a base 108 which is opposite the support face 102 (as shown in FIG. 2). In one embodiment, the top face 102 is coupled to or attached to a top side of the frame 101. In one embodiment, the platform assembly 100 further comprises a mounting point, which in some embodiments, may be a plurality of hooks or anchor points (shown FIG. 2). These can be used as locking mechanisms to keep the assembly locked down. As an example, a cable lock from a corner tiedown point of the automobile to a corner of the platform may be used. Various positions for mounting the various hooks are molded into the platform assembly 100 and may be used to restrain cargo or to ensure the platform is retained in the bed of the truck in the same position. In one embodiment, the number and positions of these hooks may change based on the platform assembly 100 that is designed for various vehicle truck beds with varying length and width.

The sides 104, 106 back 110 and front 118 are dimensioned or have a thickness such that there is a recess or open segments between sides 104, 106, back 110 and front 118 and the base 108. The recesses or open segments (shown in FIG. 2) allow legs and folding brace parts to be flush with the base 108 when they are in the “up” or stowed position to allow for the platform assembly 100 to be rolled in and out of the truck bed. The hooks comprise one or more bow hooks 122, one or more middle-line hooks 124, and one or more stern hooks 126 and may be similar to carabiner clips (though any type of clip may be used). In another embodiment, a track system (e.g., on the top side of the table) comprising flush-mounted slats where t-hooks or other connectors can be inserted to serve as anchor points and can be adjusted by moving the t-hooks in the slat in different positions. The top face may further be provided with accessory connecting members so that a user can attach appliance, power tools and the like.

Referring now to FIG. 2, a bottom perspective view and different side views of the platform assembly 100, according to one embodiment of the present disclosure, is shown. In one embodiment, the platform assembly 100 further comprises a plurality of wheel assemblies mounted to or disposed in vertical rails 202, 204, 206 and 208. The vertical rails 202, 204, 206 and 208 comprise channels (e.g., T-channel) 210, 212, 214 and 216 in which wheel assemblies are disposed. This allows the wheels to be adjusted vertically on the rails, or it allows a user to add or remove wheels easily using quick release mechanism. Segments 218, 220 and 222 allow the legs to be stowed in a recessed position so they are flush with the bottom of the sides (or positioned above the bottom of sides) to allow for ingress and egress of the assembly into and out of the truck bed.

In embodiments, the base 108 may comprise ribs or support beam features. The ribs and support beam features may be molded into the base 108 or underside of the platform assembly 100 to provide additional strength and rigidity. In one embodiment, the dimensions and positions of these features may change based on the platform assembly 100 that is designed for various vehicle truck beds with varying length and width.

In one embodiment, the plurality of vertical rails 202, 204, 206 and 208 are connected at both the top side 110 and bottom side 116, and in some embodiments, the right side 104 and left side 106 as well. In embodiments, the left rail and right rail may be formed as a unitary structure with the left side and right side, respectively. As shown, the left rail 202 is attached to the top, bottom and right side, the right rail 208 is attached to is attached to the top, bottom and left side, and the middle rails 212 and 214 are attached the top side and bottom side. Each of the rails comprise a channel, such as a t-channel 210, 212, 214, and 216, respectively, in which wheels assemblies are disposed. These channels are horizontally adjustable so that the wheels fit on top of the channels in a truck bed. Because truck bed channels differ with respect to the size and dimensions of their channels based on make and model, the adjustability of the wheels allows for even gripping and smooth ingress and egress of the assembly.

In one embodiment, the wheel assemblies 224, 226, 228 and 230 are configured to support the sliding movement of the platform assembly 100. In one embodiment, a plurality of mounting points are molded into the rails 202-208. A user may adjust the number of wheels, and the position both horizontally and vertically as further described below. This is because the position and number of mounting points may vary based on the features of the channels of n the truck bed of the vehicle. The wheel mounting points may be such that the total thickness of the base 108 and the highest point of the exposed wheel is thin, but enough to maintain rotative motion.

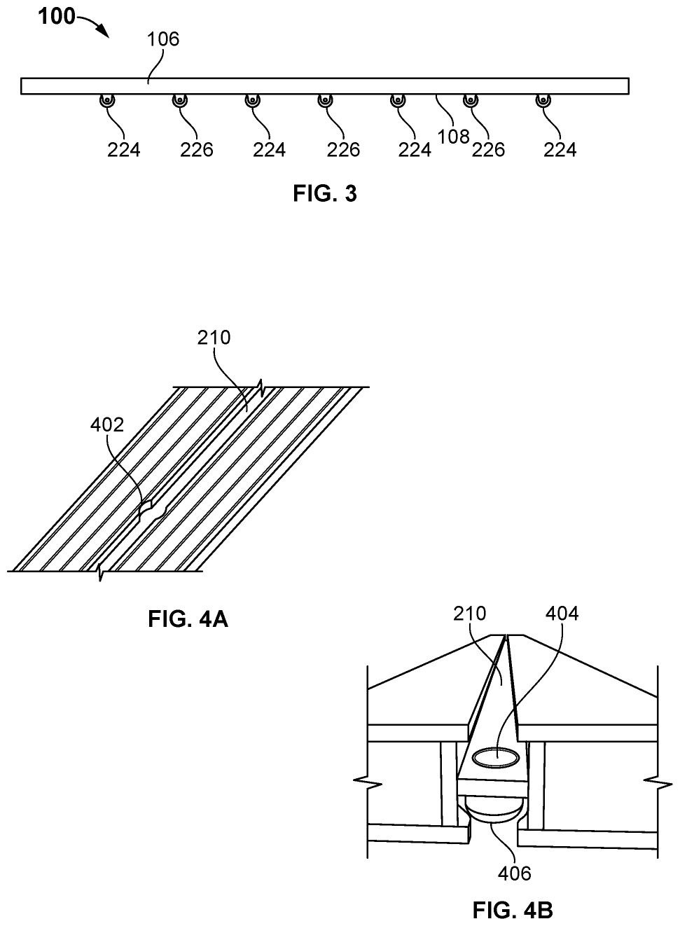

With reference to FIG. 3, a side view of the assembly is shown to illustrate that the wheels may be off-set with respect to each vertical rail 202-208, but may also be parallel as well. The user can adjust each wheel setting for optimum performance. In one embodiment, a ramp may be molded into the end of the base 108 at the rear to allows easy sliding and loading of cargo onto the base 108.

In operation, the wheels assemblies allow the platform to easily roll in and out of the bed without the need for braces and rails to be connected to the truck bed (e.g., riveted into the truck) causing mutilation to the truck bed harms resale value. Furthermore, because the wheels are dimensioned widely, they can rest on truck bed channels and still be low profile to allow the platform to sit very close to the bed, while not obstructing the user's use of the top of the table. Furthermore, the low-profile nature of the entire assembly allows the majority of the bed or cargo area as intended by the vehicle manufacturer and helps with truck owners with tonneau covers. The extra space allows user to slide in common-size boxes, ice chests, storage containers, etc.

In one embodiment, the base 108 is made from plastic materials or fiberglass/composite materials or aluminums and steel to achieve strength but also optimum weight and has varying thickness based on the platform designed for various vehicle truck beds with varying length and width.

Referring now to FIG. 4a, a perspective view of a rail of the platform assembly in one embodiment of the present disclosure is shown. The channel 210 of the rails can be seen clearly and function to mount a rolling pin style wheel that has a bracket, called a fork or a yolk. The bracket is attached to the underside of the rail with a connecting member 402 mounted in the t-channel.

FIG. 4b shows a front view of a channel of the rail of the platform assembly in one embodiment of the present disclosure. As can be seen in this figure, it provides vertical adjustability with a t-channel slot being used for wheel mounting, ideal wheel placement anywhere along the t-channel slot. Socket 404 allows a wheel assembly to be snapped into the rails, and adjustment pin 406 allows vertical sliding of the socket. Because the mounting point will be within t-channel, the user can adjust the placement of the rolling pin wheel for ideal configuration. This wheel configuration allows for the wheels to be placed anywhere on the base, and provides safety because the wheels can stick in the area between the truck bed and the gate which stops the bed from rolling all the way out when the user does not intend for it to roll out.

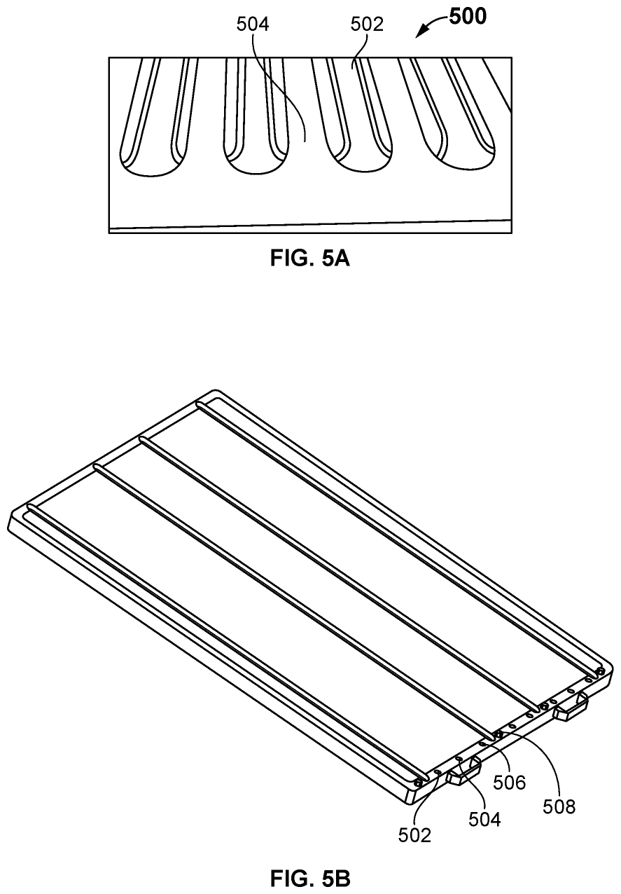

FIG. 5a shows a perspective view of a truck bed channel for which the assembly adjusts to in an embodiment of the present disclosure. This is an exemplary truck with channels that are, for example, 1.5 inches apart. The wheels are adjustable to ensure they fit on top of the channels.

FIG. 5b shows a top perspective view of the assembly for a truck bed showing adjustability mechanisms in an embodiment of the present disclosure. Tuning knobs or bolts 502, 504, 508, 510 may be used to adjust the rails horizontally to ensure wheels are appropriately positioned. A user can slide the rails horizontally via apertures in which the tuning nobs or bolts are inserted in each of the front 110 and back sides 118 via mating apertures or connectors in each of the front side and back side. A male/female connection arrangement may be used, or nut and bolt and though holes may used amongst other mating connections.

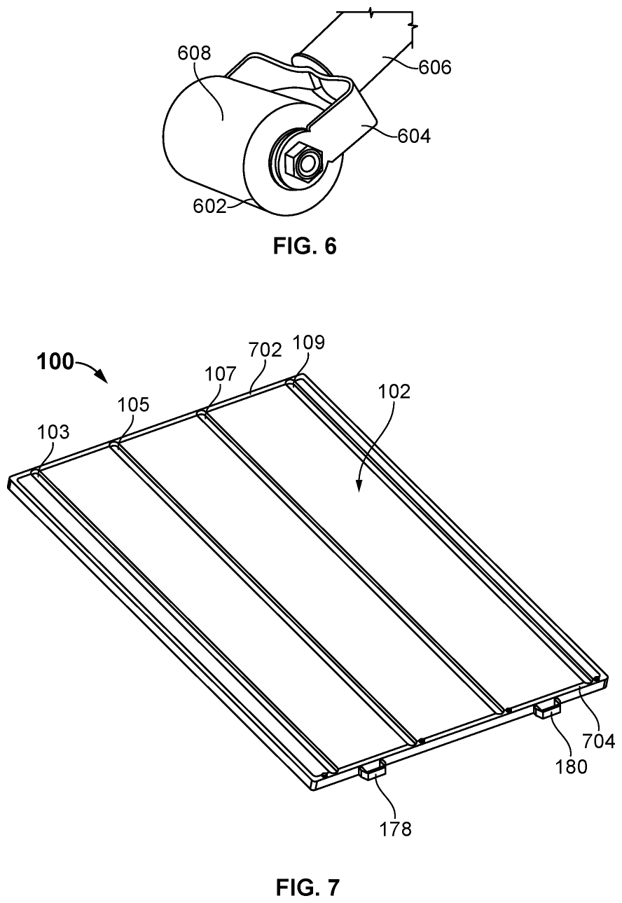

With reference now to FIG. 6, a perspective view of a wheel assembly of the platform assembly in one embodiment of the present disclosure is shown. The wheel is a rolling-pin style wheel mad of PU (Polyurethane) having a wheel width of 1.5 to 10 inches, preferably 3-8 inches and more preferably 3.5 and including two ball bearings. It was found unexpectedly that wheels having a greater width and resting directly on top of the truck bed channels, rather than within the truck bed channel, provides for more stable ingress and egress of the platform and less side-to-side unwanted motion. Also, the wider wheels avoid the issue of a narrower wheel getting off track. As shown, the wheel comprises body 602, internal shaft 608 connected to bearings on each side connected to a bracket or yolk 604, and primary shaft 606. In embodiments, the wheel does not have an internal shaft and the bearings are attached to the yolk without the shaft. The primary shaft 606 is connectable to a socket in the channel. The wheel assembly comprises:

FIG. 7 shows a top perspective view a base of the platform assembly with adjustment pins in one embodiment of the present disclosure. As shown, the platform assembly 100 has vertical rails 202, 204, 206 and 208 and the vertical rails 202, 204, 206 and 208 comprise channels (e.g., T-channel) 210, 212, 214 and 216 in which wheel assemblies are disposed. In this embodiment, the wheels, via the rails, can be adjusted horizontally on the rails via front channel 702 and back channel 704. The rails 202, 204, 206 and 208 can be slid by the user on rails and locked in place via a nut and bolt assembly or other locking assemblies so that the wheels are positioned properly on the truck bed channels.

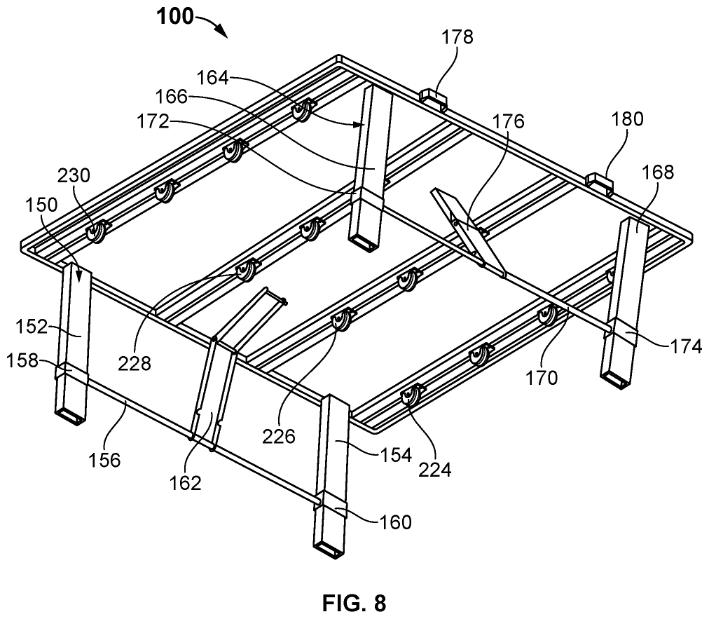

With reference now to FIGS. 8-13, one embodiment of foldable leg assemblies is shown, though other types of foldable leg assemblies may be used. FIG. 8 shows a bottom perspective the base of the platform assembly having legs in an open position in one embodiment of the present disclosure. In one embodiment, the platform assembly 100 further comprises one or more leg assemblies and in some embodiments. comprises at least two sets of leg assemblies. The leg assemblies may be any type of foldable legs, and in this embodiment, the leg assemblies comprise a bow leg assembly 150 and a stern leg assembly 164. The leg assemblies 150 and 164 may be height adjustable.

In one embodiment, the bow leg assembly 150 comprises a right bow leg 152 and a left bow leg 154. The bow leg assembly 150 may have a bow bracket 156 attached to a lower end (or non-adjustable portion) of each bow leg 152 and 154. In one embodiment, the bow bracket 156 may have one or more cuffs at both ends. The one or more cuffs include a right bow cuff 158 and a left bow cuff 160. The bow bracket 156 may be attached to the lower end of the bow legs (152 and 154) using the bow cuffs 158 and 160. The right bow cuff 158 is attached to the lower end of the right bow leg 152 and the left bow cuff 160 is attached to the lower end of the left bow leg 154. In operation, the cuffs may act as locking mechanisms to hold the table to the adjustable height chosen by the user.

The bow leg assembly 150 further may have a middle bow brace 162. The middle bow brace 162 comprises a first end and a second end. The first end of the middle bow brace 162 is attached to the base 108 of the platform assembly 100, whereas the second end is attached to the bow bracket 156. In operation, the bow brace provides rigidity when the legs are in an open position, and also provides a lever or fulcrum from which the legs can fold.

The stern leg assembly 164 comprises a pair of stern legs including a right stern leg 166 and a left stern leg 168. In one embodiment, the stern leg assembly 164 further comprises a stern bracket 170. The stern bracket 170 is attached to a lower end of each stern leg 166 and 168. In one embodiment, the stern bracket 170 comprises one or more cuffs at both ends. The one or more cuffs include a right stern cuff 172 and a left stern cuff 174. The stern bracket 170 is attached to the lower end of the stern legs 166 and 168 using the stern cuffs 172 and 174. The right stern cuff 172 is attached to the lower end of the right stern leg 166 and the left stern cuff 174 is attached to the lower end of the left stern leg 168. The stern leg assembly 164 further comprises a middle stern brace 176. The middle stern brace 176 comprises a first end and a second end. The first end of the middle stern brace 176 is attached to the base 108 of the platform assembly 100, whereas the second end is attached to the stern bracket 170. The cuffs and braces may act similarity to the those described above with relation the bow legs, cuffs, and braces.

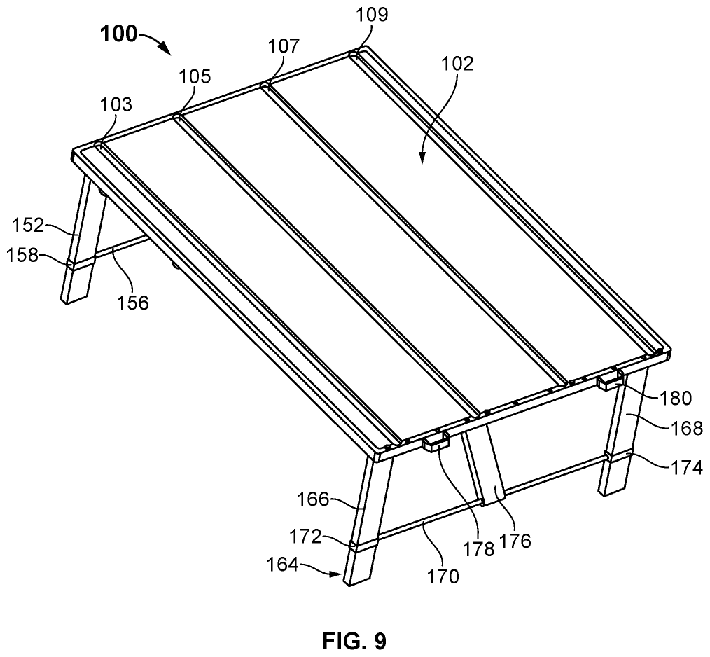

In one embodiment, each middle brace 162 and 176 comprises an interior bore for receiving the brackets 156 and 170. The middle stern brace 176 comprises an interior bore 182 for receiving the stern bracket 170 as shown in FIG. 7. In one embodiment, each middle brace (162 and 176) further comprises a lever configured to provide quick-lock mechanism for easily folding/unfolding the leg assemblies. In one embodiment, the middle stem brace 176 comprises a lever 184 configured to provide quick-lock mechanism for easily folding/unfolding the leg assemblies as shown in FIGS. 8 and 9.

In another embodiment, the platform assembly 100 further comprises one or more handles or hand hold features. In one embodiment, the handles are molded into the platform assembly 100 configured to allow the user to easily slide the platform assembly 100 in and out from the truck bed of the pick-up truck. In one embodiment, the one or more handles include a right stern handle 178 and a left stern handle 180 as shown in FIG. 6. In one embodiment, the handles 178 and 180 are provided at the slope 118 and configured to allow the user to hold the platform assembly 100 to slide in and out from the truck bed.

Referring now to FIG. 9, a bottom view of the platform assembly 100 with folded leg assemblies, according to one embodiment of the present disclosure, is shown. In one embodiment, each leg of the leg assemblies 150 and 164 comprises a pivot joint configured to allow folding and unfolding of the leg assemblies 150 and 164. The stern leg assembly 166 also comprises one or more pivot joints or pivot points 186. The legs of the stern leg assembly 166 are connected to the stern bracket 170 using these pivot joint 186. The pivot joint 186 comprises a pivot bolt or rod 188 for connecting the legs to the stern bracket 170, thereby providing pivotable movement of the legs for uneven surfaces.

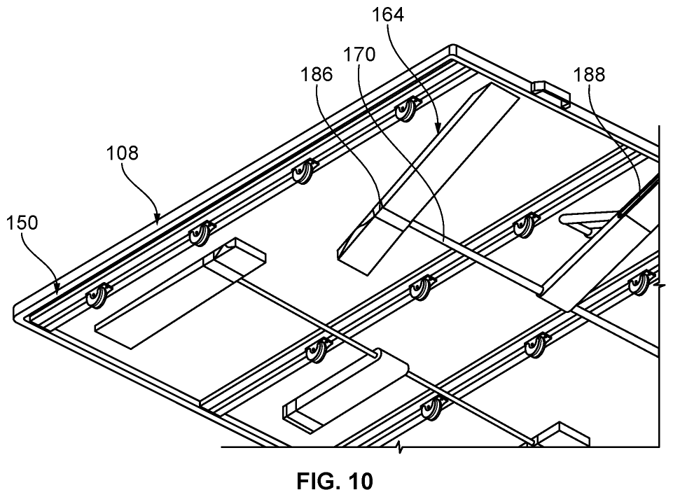

FIG. 10 shows a bottom perspective view of the base of the platform assembly with legs in a stowed position in one embodiment of the present disclosure.

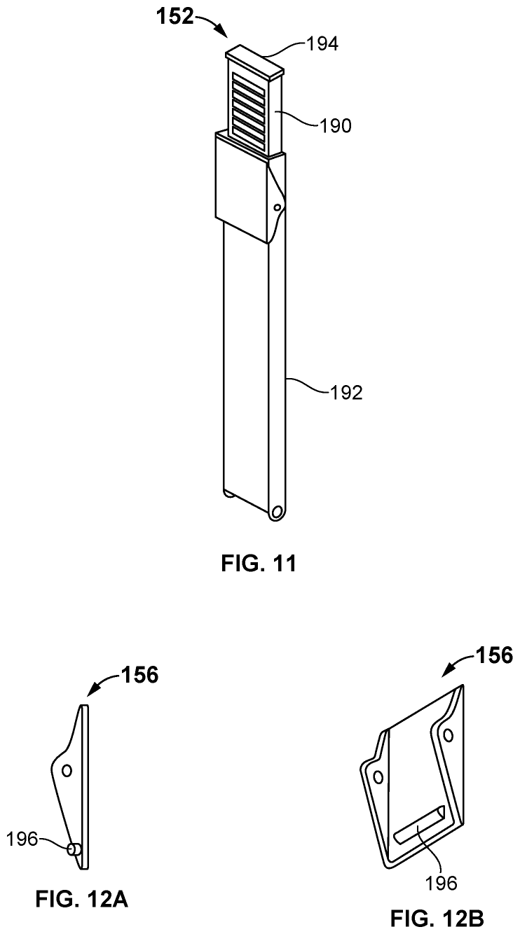

With reference now FIG. 11, an exemplary single leg of any leg assemblies in one embodiment of the present disclosure.

The single leg may be any of the left bow leg 154, right stern leg 166, or left stern leg 168, though in this embodiment the right bow leg 152 is shown, and comprises an inner channel 190 and an outer channel 192. In one embodiment, the left bow leg 152 is able to fold via the pivot points 186 utilizing hinge rods and bushings, for example. In one embodiment, the legs (152, 154, 166, and 168) are height adjustable by sliding leg via the inner channel 190 in or out of the outer channel 192. In one embodiment, the leg 152 further comprises a plastic foot or end cap 194. The end cap 194 is fixed to one end of the inner channel 190 to protect it from wear when it is in contact with the ground. Further, the height, width, and wall thickness of the leg parts may change based on the platform assembly 100 that is designed for various vehicle truck beds with varying length and width.

Referring FIGS. 12a and 12b, different views of the locking bracket 156, according to one embodiment of the present disclosure is shown. In one embodiment, the locking bracket 156 has a tab 196. In one embodiment, the tab 196 is a height-adjustable locking tab configured to adjust the height of the legs and is used to engage a series of slots cut into the inner channel 190 to fix the inner channel 190 at a given position. The locking bracket 156 may be spring-loaded in the locking position to fix the height of the inner and outer channels 190 and 192, though other types of mechanisms may be used. In one embodiment, the locking bracket 156 is depressed to slide the leg in or out in a telescoping arrangement, though other arrangements may be used.

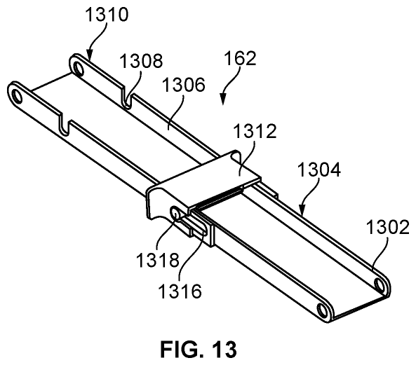

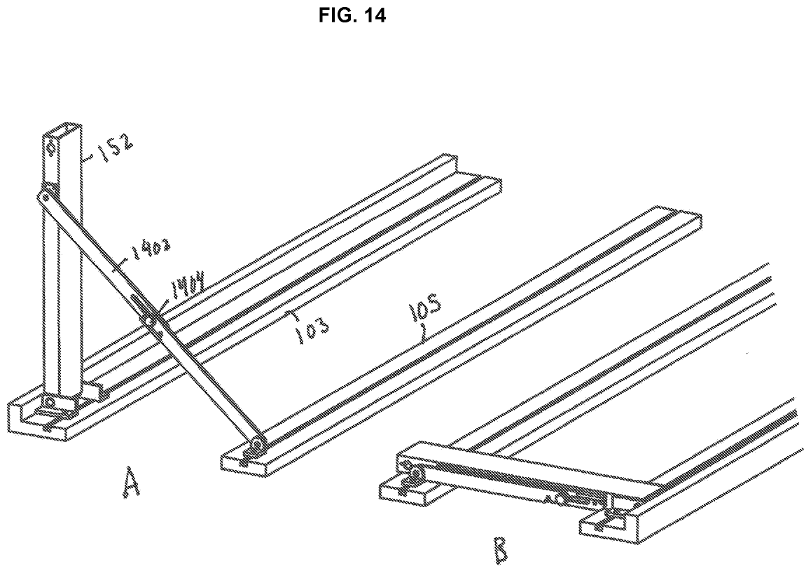

A brace assembly of any leg assemblies, according to one embodiment of the present disclosure is shown. In one embodiment, the brace assembly comprises middle bow brace 162 and middle stern brace 176. In operation, the bow brace 162 is mounted between the bow legs (152 and 154) in order to provide strength and rigidity to the bow legs (152 and 154). When the bow legs (152 and 154) are in the down position, they may act as table legs. The bow brace 162 may be a folding brace composed of several parts/components including inner brace 198 and an outer brace 1310 (shown in FIG. 13). In one embodiment, the height, width, and wall thickness of the brace parts may change based on the platform assembly 100 that is designed for various vehicles truck beds with varying length and width. In one embodiment, the folding of brace 162 is accomplished via three pivot points, though other pivoting mechanisms and pivot points may be used. The pivot points may utilize one or more hinge rods and bushings.

With reference to FIG. 13, In one embodiment, the inner brace 1304 comprises at least two side walls 1302, and the outer brace 1310 comprises at least two side walls 1308 and one or more recesses 1308 cut into the side walls 1306. The recesses 1308 are configured to allow for clearance of the brace hinge rod when the brace 162 is in stowed position. In one embodiment, the dimensions and geometry of the pivot points may vary based on the platform assembly 100 that is designed for various vehicles truck beds with varying length and width. The geometry is specifically designed to allow the legs and braces to fold flush with the base 108 of the platform assembly 100.

FIG. 13 shows a brace assembly in one embodiment of the present disclosure. In one embodiment, the brace 162 further comprises a channel 1316. The channel 1318 is cut into the outer brace 200 to allow for a pivot pin 1318 mounted in the inner brace 198 to side back and forth allowing for the folding action.

In one embodiment, the brace 162 further comprises a sliding lock sleeve 1304. The sliding lock sleeve 1312 is used to fix the two parts of the folding brace 162 in the down position. When the legs are in down position, the sliding lock sleeve 1312 slides towards the pivot pin in the inner leg and securely snapped in place. In one embodiment, the sliding lock sleeve 1316 may be slid back and forth on the outer brace. In one embodiment, the sliding lock sleeve 1312 is made of a material including, but not limited to, plastic. Further, the sliding lock sleeve 1312 is molded with a feature configured to allow the sliding lock sleeve 1312 to be slid over the pin and locked into place.

In one embodiment, the sliding lock sleeve 1312 further comprises a plurality of teeth molded into the inner area, though compression mechanisms may also be used. The teeth are configured to ride on the flat surfaces of the inner brace side walls 1302 when the brace 162 is in extended or down position. The teeth prevent the pivot pin from rotating in the channel of the outer brace thus keeping both parts fixed rigidly together. In one embodiment, the folding of leg assembly is accomplished by un-snapping the sliding lock sleeve 1312 from the pivot pin and sliding towards the leg cross brace 162 to the stowed position. The legs are then folded into the base 108 and the sliding lock sleeve 1312 and configured to fit into a recess or segment in the platform assembly 100. In one embodiment, the sliding lock sleeve 210 comprises one or more tabs molded thereto and configured to allow the user to easily grasp the lock to snap it over the pivot point or remove it from the pivot point. Further, the height, width, and wall thickness of the sliding lock sleeve 1312 may change based on the dimensions of the folding brace components.

FIG. 14 shows a bottom perspective of the base of the platform assembly with leg assemblies that close inwardly parallel in an open position and stowed position in one embodiment of the present disclosure. In this embodiment, the leg 154 is folded towards the horizontal inward lane to be stowed as shown in view B (while view A show the legs extended). Brace 1402 via pivot pin 1402 allows the leg to fold inwardly into the base. This embodiment also shows how the left rail and left side are a unitary structure.

The platform assembly may be locked into bed using locking mechanisms such as a catch lock or latch lock in which the user applies pressure forward to unlock the platform assembly to pull it out and may apply pressure forward to lock it back in place, or other types of locking assemblies. Other locking mechanisms that may be used include any type of lock suitable to keep the platform in the bed safely. The locking mechanisms may comprise an anti-theft deterrent, be flush mounted or surface mounted, and may comprise a key or code lock or other identifying mechanism (e.g., a smart locking mechanism that may connect to a user device). The locking mechanism may be mounted near the long-side edge of the base (e.g., closer to the truck liftgate). In the locked position, the table is locked into the bed and cannot be removed. In the unlocked position, the table may slide out of the open tailgate or be used to create a two-legged or four-legged table. Furthermore, the straight cam bar (the component of the lock that locks into a part of the truck bed) may act as the main contact point that locks the table into the bed.

According to the present disclosure, the platform assembly 100 of the present disclosure may be fabricated using the following materials, processes and parameters. The platform assembly 100 may be relatively light in weight, for example, less than 50 lbs. The platform assembly 100 may be made of any one of a material including, but not limited to, light polypropylene, polypropylene/fiberglass, polypropylene honeycomb composite, steel, aluminum, or other suitable materials. The platform assembly 100 further comprises one or more mounting points, interchangeable panels, different anti-slip finishes, and licensed logos. The platform assembly 100 may be customizable to cover the entire surface of the truck bed. The platform assembly 100 has a low profile because the wheels are partially concealed into the bed. The platform assembly 100 may be less than 2″ in height. Further, the platform assembly 100 is less expensive to construct compared to other known beds.

Advantageously, the platform assembly of the present disclosure is safe and easy to operate. The platform assembly slides in and out and may also be taken out completely to use as a separate table. It is low profile, allowing the majority of the cargo area to be used as intended by vehicle manufacturer. It does not require any permanent modification to the vehicle or trailer is light weight.

Preferred embodiments of this disclosure are described herein, including the best mode known to the inventors for carrying out the disclosure. It should be understood that the illustrated embodiments are exemplary only and should not be taken as limiting the scope of the disclosure.

The foregoing description comprise illustrative embodiments of the present disclosure. Having thus described exemplary embodiments of the present disclosure, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments of the disclosure will come to mind to one skilled in the art to which this disclosure pertains having the benefit of the teachings in the foregoing descriptions. Although specific terms may be employed herein, they are used only in generic and descriptive sense and not for purposes of limitation. Accordingly, the present disclosure is not limited to the specific embodiments illustrated herein.

1. A cargo bed for an automobile, the cargo bed comprising:
a frame having a first side, a second side, a front side and a back side;
a top face supported by the frame, wherein the top face is configured to support cargo;
a plurality of vertical rails positioned in parallel with the first side and the second side and under the top face, wherein each of the plurality of the vertical rails comprises:
a vertical channel disposed therein;
a wheel assembly positioned in the vertical channel;
a plurality of rail mating connectors positioned at each end of the vertical rails, wherein the rail mating connector is configured to mate with the front side and the back side of the frame at predetermined positions so that the vertical rails are adjustable horizontally along the front side and the back side.

2. The cargo bed of claim 1, further comprising a leg assembly, wherein the leg assembly comprises a bow leg assembly and a stern leg assembly, wherein the leg assembly is configured to fold into recesses of the frame when in a stowed position in an automobile bed.

3. The cargo bed of claim 2, wherein the leg assembly, in a stowed positioned, is positioned approximately flush with the vertical rails, and positioned above the wheel assembly when in the stowed position to allow for the bed to be rolled in to and out of the automobile bed.

4. The cargo bed of claim 1, wherein the wheel assembly is adjustable vertically with the channel, and wherein the rail assemblies comprise sockets positioned in the channels such that a user can adjust a position of the wheel assemblies.

5. The cargo bed in claim 1, wherein the plurality of vertical rails comprise a left vertical rail attached to the left side, the top side, and the bottom side, two middle vertical rails connected to the top side and the bottom side, and a right vertical rail attached to the left side, the top side and the bottom side.

6. The cargo bed of claim 5, wherein the left vertical rail comprises four wheel assemblies, the two middle vertical rails comprise three wheel assemblies, and the right vertical rail has four wheel assemblies, wherein the middle rail wheel assemblies are off-set relative to the left and right vertical rails when assemblies.

7. The cargo bed of claim 1, wherein the rail mating connector comprises a plurality of mounting apertures on the vertical rail and a plurality of mating apertures on the front rail and the back rail, and a bolt configured to connect the vertical rail to the top and bottom rail at different positions on the top and the bottom rail.

8. The cargo bed of claim 4, wherein the wheel assembly comprises:
a wheel body;
internal shaft supporting the wheel body, wherein the internal shaft is connected to bearings;
a yolk connected to the bearings, wherein the yolk is connectable to the sockets in the channel.

9. The cargo bed of claim 8, wherein the wheel body has a width of between 1.5 inches and 10 inches.

10. The cargo bed of claim 2, wherein the leg assemblies comprise a pivot joint configured to allow folding and unfolding of the leg assemblies.

11. A method for removing a cargo bed from a cargo area to load and unload cargo, the method comprising
providing a frame having a first side, a second side, a front side and a back side;
supporting cargo using a top face supported by the frame;
adjusting a width of a plurality of vertical rails positioned in parallel with the first side and the second side and under the top face, wherein each of the plurality of the vertical rails comprises:
a vertical channel disposed therein;
a wheel assembly positioned in the vertical channel;
a plurality of rail mating connectors positioned at each end of the vertical rails, wherein the rail mating connector is configured to mate with the front side and the back side of the frame at predetermined positions so that the vertical rails are adjustable horizontally along the front side and the back side;
pulling, pushing, or both, the cargo bed into and out of an automobile.

12. The method of claim 11, folding a leg assembly into a recesses of the frame when in a stowed position in an automobile bed.

13. The method of claim 12, wherein the leg assembly, in a stowed positioned, is positioned approximately flush with the vertical rails, and positioned above the wheel assembly when in the stowed position to allow for the bed to be rolled in to and out of the automobile bed.

14. The method of claim 11, further comprising vertically adjusting the wheel assemblies on the vertical rails using a channel, wherein the rail assemblies comprise sockets positioned in the channels.

15. The method of claim 11, wherein the plurality of vertical rails comprise a left vertical rail attached to the left side, the top side, and the bottom side, two middle vertical rails connected to the top side and the bottom side, and a right vertical rail attached to the left side, the top side and the bottom side.

16. The method of claim 15, wherein the left vertical rail comprises four wheel assemblies, the two middle vertical rails comprise three wheel assemblies, and the right vertical rail has four wheel assemblies, wherein the middle rail wheel assemblies are off-set relative to the left and right vertical rails when assemblies.

17. The method of claim 11, wherein the rail mating connector comprises a plurality of mounting apertures on the vertical rail and a plurality of mating apertures on the front rail and the back rail, and a bolt configured to connect the vertical rail to the top and bottom rail at different positions on the top and the bottom rail.

18. The method of claim 15, wherein the wheel assembly comprises:
a wheel body;
internal shaft supporting the wheel body, wherein the internal shaft is connected to bearings;
a yolk connected to the bearings, wherein the yolk is connectable to the sockets in the channel.

19. The cargo bed of claim 8, wherein the wheel body has a width of 1.5 inches to 10 inches.

20. The method of claim 12, wherein the leg assemblies comprise a pivot joint configured to allow folding and unfolding of the leg assemblies.
